(19) United States
(12) Patent Application Publication
(10) Pub. No.: US 2026/0101111 A1
(43) Pub. Date: Apr. 9, 2026

(54) CONTROL APPARATUS, IMAGING MOVABLE UNIT, CONTROL METHOD, AND STORAGE MEDIUM

(71) Applicant: CANON KABUSHIKI KAISHA, Tokyo (JP)

(72) Inventor: HIROTAKA SHINDO, Tokyo (JP)

(21) Appl. No.: 19/317,609

(22) Filed: Sep. 3, 2025

(30) Foreign Application Priority Data
Oct. 9, 2024 (JP) 2024-176834

(51) Int. Cl. H04N 23/695; H04N 23/55; H04N 23/698

(52) U.S. Cl. CPC H04N 23/695; H04N 23/55; H04N 23/698

(57) ABSTRACT

Control apparatuses, imaging movable units, control methods, and storage media are provided herein. One or more control apparatuses configured to control an imaging movable unit that includes a movable unit, and an imaging unit mounted on the movable unit and configured to perform imaging through an optical system that includes an optical member rotatable and configured to bend an optical path from an object may include one or more memories storing instructions, and one or more processors that, upon execution of the instructions, operate to generate control information for controlling the movable unit, and control a rotation position of the optical member based on an estimated orientation of the movable unit that has been controlled based on the control information.

### BACKGROUND

### Field of the Technology

The aspect of the disclosure relates to one or more embodiments of control of a movable unit that can perform imaging.

### Description of the Related Art

Drones and other movable units may have cameras for aerial photography and the like. For example, the camera can be held by a rotation mechanism (such as a gimbal) provided on the movable unit, and the imaging range of the camera can be changed by operating the rotation mechanism.

The camera mounted on the movable unit can have a bending optical system including a mirror, as disclosed in Japanese Patent Application Laid-Open No. 2008-116836. The imaging range can be changed by rotating the mirror within the bending optical system, and can avoid any influence on the movement and orientation of the movable unit due to the operation of the rotation mechanism as described above.

### SUMMARY

One or more embodiments of a control apparatus configured to control an imaging movable unit that includes a movable unit, and an imaging unit mounted on the movable unit and configured to perform imaging through an optical system that includes an optical member rotatable and configured to bend an optical path from an object according to one or more aspects of the disclosure may include one or more memories storing instructions, and one or more processors that, upon execution of the instructions, operate to generate control information for controlling the movable unit, and control a rotation position of the optical member based on an estimated orientation of the movable unit that has been controlled based on the control information. One or more embodiments of an imaging movable unit may include one or more control apparatuses in accordance with one or more other aspects of the disclosure. One or more control methods corresponding to the above one or more control apparatuses also constitutes another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of an imaging drone according to this embodiment.

FIG. 2 is a flowchart illustrating imaging processing according to an embodiment.

FIGS. 3A and 3B are external views of the imaging drone according to this embodiment.

FIG. 4 illustrates the configuration of a camera according to this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

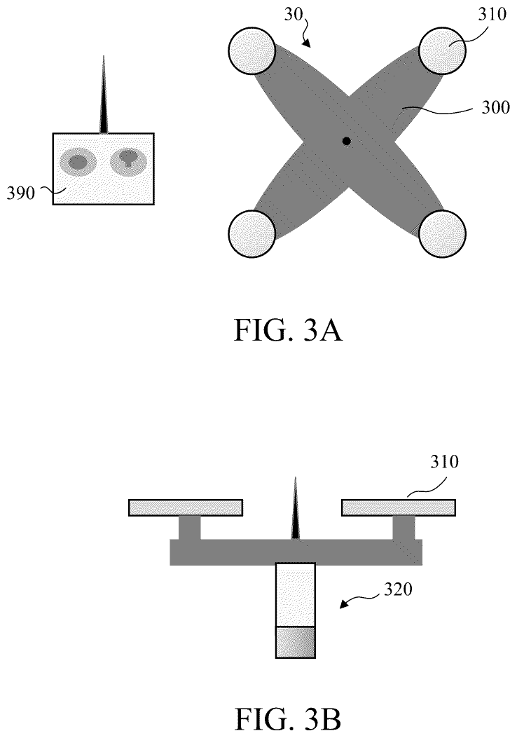

FIGS. 3A and 3B illustrate the appearance of an imaging drone 30 as an imaging movable unit when viewed from above and side, respectively. The imaging drone 30 includes a drone (body) 300, which is an air vehicle as a movable unit, and a camera 320 as an imaging unit. FIG. 3A illustrates an instruction apparatus (transmitter or remote controller) 390 that enables a user to remotely control the drone 300 and the camera 320.

The drone 300 includes propellers 310 at the tips of the four arms of the aircraft, and flies by rotating these propellers 310. The camera 320 is mounted on the bottom of the aircraft. The detailed configuration of the camera 320 will be described later.

The transmitter 390 is a transmitter configured to transmit instructions to the imaging drone 30 according to user operations. The instructions include instructions regarding the flight of the drone 300 and instructions regarding the imaging condition and imaging range of the camera 320. Instead of the transmitter 390, an automatic instruction apparatus such as a personal computer that automatically controls the imaging drone 30 remotely may be used.

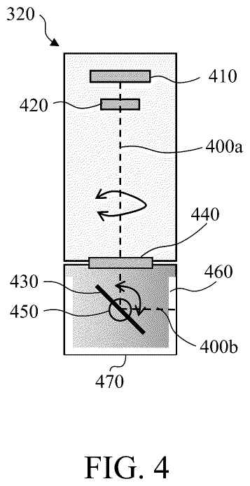

FIG. 4 illustrates the configuration of the camera 320. The camera 320 is disposed so as to extend downward from the body side of the drone 300, and includes an image sensor 410 on the body side and an imaging optical system below the image sensor 410. The image sensor 410 is a photoelectric conversion element such as a CCD sensor or a CMOS sensor, and photoelectrically convert (captures) an object image formed by the imaging optical system.

The imaging optical system is a bending optical system including a bending mirror 430 as an optical member that bends the optical path of incident light. Of the optical axes of the bending optical system (illustrated by a broken line in FIG. 4), a main optical axis 400a on the image side of the bending mirror 430 is orthogonal to the imaging surface of the image sensor 410. Of the optical axes, an objective optical axis 400b on the object side of the bending mirror 430 faces the object. The bending mirror 430 can rotate around a pan axis and a tilt axis, which will be described later. The optical member that bends the optical path of the incident light is not limited to a mirror, and may be another optical member such as a prism.

Light from the object that is taken into the bending optical system through an objective window 460 is reflected by the bending mirror 430, passes through the zoom lens 420, and is imaged on the image sensor 410. A zoom lens 420 changes the imaging angle of the camera 320 by moving along the main optical axis 400a. The imaging angle of view can be changed within a range smaller than 360° horizontally and 180° vertically (for example, 30° to 45° horizontally and 20° to 30° vertically). The bending optical system may not have the zoom lens 420, and may have a lens that images the light from the bending mirror 430.

A horizontal rotation mechanism 440, which is a first drive unit, rotates an objective unit 470, which includes the bending mirror 430, a vertical rotation mechanism 450, which is a second drive unit, and the objective window 460, around a pan axis that coincides with the main optical axis 400a. Thereby, the imaging range of the camera 320 is changed (panned) in the horizontal direction, which is the first direction. The vertical rotation mechanism 450 rotates the bending mirror 430 around a tilt axis perpendicular to the main optical axis 400a and the objective optical axis 400b so as to change an angle in the vertical direction between the main optical axis 400a and the objective optical axis 400b. Thereby, the imaging range of the camera 320 is changed (tilted) in the vertical direction, which is the second direction.

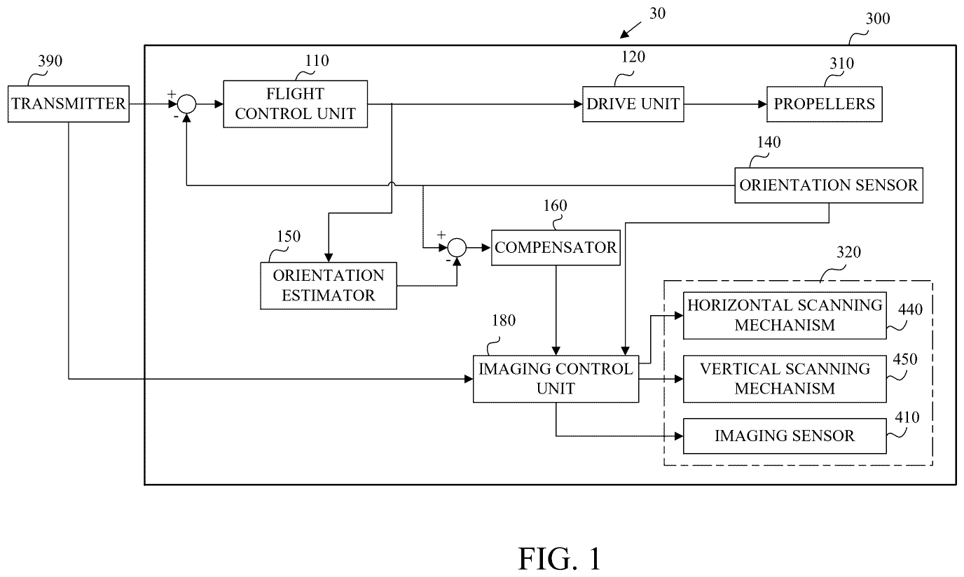

FIG. 1 illustrates the electrical configuration of the imaging drone 30. The drone 300 includes a flight control unit 110, a drive unit 120, an orientation sensor 140, an orientation estimator 150, a compensator 160, and an imaging control unit 180 inside the imaging drone 30. The camera 320 includes the image sensor 410, the horizontal rotation mechanism 440, and the vertical rotation mechanism 450 described above.

In the drone 300, the flight control unit 110 as a first control unit (one or more processors) generates and outputs a flight control amount as control information for controlling the flight of the drone 300 according to an instruction from the transmitter 390. The flight control amount is a control amount relating to the rotation number (the number of rotations, rotation speed, or revolutions per minutes (RPM)) of the propellers 310 and the orientation (tilt) of the drone 300. The drive unit 120 flies the drone 300 by rotating the propellers 310 at the rotation number corresponding to the flight control amount output from the flight control unit 110 and tilting the drone 300.

The orientation sensor 140 as a detector includes an acceleration sensor, a gyro sensor, a Global Positioning System (GPS) sensor, or the like, and detects the orientation of the drone 300. The flight control unit 110 outputs the flight control amount by PID feedback control using a signal in accordance with the detected orientation from the orientation sensor 140.

The orientation estimator 150 obtains and outputs an orientation estimation value indicating the estimated orientation of the drone 300 after flight control based on the flight control amount output from the flight control unit 110. After flight control based on the flight control amount here, flight control based on the flight control amount is also included. At this time, the flight control unit 110 may read out an orientation estimation value corresponding to the flight control amount from the flight control unit 110 from table data storing the orientation estimation value for each of the plurality of flight control amounts. In addition, the orientation estimation value may be an average of detected orientations obtained multiple times for the same flight control amount in the past.

The imaging control unit 180 outputs a rotation control amount for rotation control of the horizontal rotation mechanism 440 and the vertical rotation mechanism 450 in the camera 320 (i.e., control of the rotation position of the bending mirror 430). The imaging control unit 180 controls imaging by the image sensor 410. The orientation estimator 150 and the imaging control unit 180 constitute a second control unit (one or more processors). The flight control unit 110, the orientation estimator 150, and the imaging control unit 180 constitute a control apparatus.

The compensator 160 adds a compensation value corresponding to a difference between the orientation estimation value obtained by the orientation estimator 150 and the actual orientation detected by the orientation sensor 140 to the horizontal rotation control amount and the vertical rotation control amount output from the imaging control unit 180 to the horizontal rotation mechanism 440 and the vertical rotation mechanism 450, respectively. Thereby, a change in the imaging range of the camera 320 caused by the change in orientation of the drone 300 can be corrected.

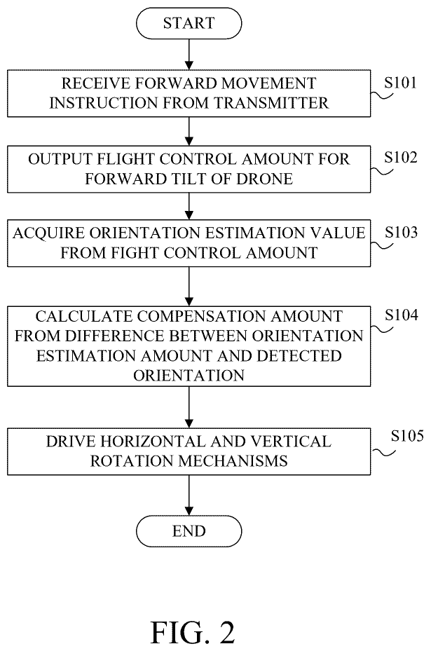

A flowchart in FIG. 2 illustrates the processing (a control method) mainly executed by the flight control unit 110, the orientation estimator 150, the compensator 160, and the imaging control unit 180 in this embodiment. The flight control unit 110, the orientation estimator 150, the compensator 160, and the imaging control unit 180 include a computer including a CPU, etc., and execute this processing according to a program (instructions) stored in one or more memories.

Next follows a description of a case where the user specifies a hemispherical imaging range of 360° horizontally and 180° vertically downward through the transmitter 390 and starts imaging in the imaging drone 30 during forward flight. The horizontal rotation mechanism 440 rotates the objective unit 470 (i.e., the bending mirror 430) 360° around the pan axis. The vertical rotation mechanism 450 rotates the bending mirror 430 around the tilt axis between a position where the objective optical axis 400b is orthogonal to the main optical axis 400a and a position where the light reflected from the object reaches the imaging surface of the image sensor 410 at its limit. Thereby, the camera 320 can perform full-circumference (all-around) imaging of 360° horizontally and hemispherical imaging of 180° vertically downward. At this time, the camera 320 may perform still image capturing at a plurality of imaging positions (e.g., positions every) 10° in each of the imaging ranges of 360° horizontally and 180° vertically downward to obtain a hemispherical image by combining the obtained multiple still images, or may perform continuous moving image capturing.

First, in step S101, the flight control unit 110 receives a forward movement instruction from the transmitter 390.

Next, in step S102, the flight control unit 110 outputs a flight control amount that controls the drone 300 to tilt forward in order to fly the drone 300 forward. Thereby, the drone 300 starts tilting forward in accordance with the flight control amount output in step S102.

As the forward tilt starts, in step S103, the orientation estimator 150 outputs an orientation estimation value (e.g., a forward tilt angle of 10°) obtained from the flight control amount for the forward tilt (orientation change) output in step S102.

In step S104, the compensator 160 outputs a compensation amount according to a difference between the orientation estimation value from the orientation estimator 150 and the orientation actually detected by the orientation sensor 140.

Then, in step S105, the imaging control unit 180 adds the compensation amount output in step S104 to the horizontal rotation control amount and vertical rotation control amount corresponding to the above multiple imaging positions, and outputs the result to the horizontal rotation mechanism 440 and the vertical rotation mechanism 450. At this point, the drone 300 completes its forward tilt.

This controls the rotation positions of the bending mirror 430 in the horizontal and vertical directions in accordance with the forward tilt angle of the drone 300, thereby avoiding framing out of the object from the imaging range. Furthermore, controlling the horizontal and vertical rotations of the bending mirror 430 can provide high-definition full-circumference imaging and hemispherical imaging.

This embodiment controls the rotation position of the bending mirror 430 based on the estimated orientation of the drone 300 after flight control (orientation change) obtained from the flight control amount (control information) of the drone 300 and the detected orientation by the orientation sensor 140.

This embodiment is not limited to mere control of the rotation position of the bending mirror 430 according to the orientation change for the flight of the drone 300. For example, the rotation position of the bending mirror 430 is controlled according to a difference between the estimated orientation value (e.g., tilt 0°) in hovering control at a fixed position in the air and the detected orientation of the drone 300 that has swayed due to external factors such as wind. Thereby, the object can be avoided from framing out of the imaging range even if the orientation of the drone 300 changes due to external factors.

The configuration in which the objective unit of the dioptric optical system and a small part of the bending mirror are rotated as in this embodiment can avoid the disadvantage of the reaction generated by operating a mechanism that rotates the entire camera, such as a gimbal, affecting the flight and orientation of the drone.

In this embodiment, the rotation position of the bending mirror is controlled based on a difference between the estimated orientation and the detected orientation of the drone, but the rotation position of the bending mirror may be controlled based only on the estimated orientation of the drone. For example, such control can be achieved in a case where there is almost no difference between the estimated orientation and the actual orientation of the drone, and the last estimated orientation can be considered as the actual orientation before the current flight control.

In this embodiment, the control apparatus including the imaging control unit 180 and the flight control unit 110 is built in the imaging drone 30, but the control apparatus may be provided outside the imaging drone. In this case, a personal computer or a transmitter capable of communicating with the imaging drone can be used as the control apparatus, and the control apparatus transmits the generated flight control amount and rotation control amount to the imaging drone.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The embodiment according to the disclosure can suppress framing out of an object caused by the orientation change in an imaging movable unit that performs imaging using a bending optical system.

This application claims the benefit of Japanese Patent Application No. 2024-176834, which was filed on Oct. 9, 2024, and which is hereby incorporated by reference herein in its entirety.

What is claimed is:

1. A control apparatus configured to control an imaging movable unit that includes a movable unit, and an imaging unit mounted on the movable unit and configured to perform imaging through an optical system that includes an optical member rotatable and configured to bend an optical path from an object, the control apparatus comprising:
one or more memories storing instructions; and
one or more processors that, upon execution of the instructions, operate to:
generate control information for controlling the movable unit, and
control a rotation position of the optical member based on an estimated orientation of the movable unit that has been controlled based on the control information.

2. The control apparatus according to claim 1, further comprising a detector configured to detect an orientation of the movable unit,
wherein the one or more processors operate to control the rotation position of the optical member based on a difference between the estimated orientation and the orientation detected by the detector.

3. The control apparatus according to claim 1, wherein the one or more processors operate to generate the control information according to an instruction input from an instruction apparatus operable by a user or automatically controlling the movable unit.

4. The control apparatus according to claim 1, wherein the one or more processors operate to control a first drive unit configured to rotate the optical member in a first direction, and a second drive unit configured to rotate the optical member in a second direction different from the first direction.

5. The control apparatus according to claim 4, wherein the one or more processors operate to rotate the optical member by 360° in the first direction to cause the imaging unit to perform all-around imaging.

6. The control apparatus according to claim 1, wherein the movable unit is an aircraft.

7. The control apparatus according to claim 6, wherein the one or more processors operate to control the aircraft to tilt based on the control information.

8. An imaging movable unit comprising:
a movable unit;
an imaging unit mounted on the movable unit and configured to perform imaging through an optical system that includes an optical member rotatable and configured to bend an optical path from an object; and
a control apparatus configured to control an imaging movable unit that includes the movable unit and the imaging unit,
wherein the control apparatus includes:
one or more memories storing instructions; and
one or more processors that, upon execution of the instructions, operate to:
generate control information for controlling the movable unit, and
control a rotation position of the optical member based on an estimated orientation of the movable unit that has been controlled based on the control information.

9. A control method configured to control an imaging movable unit that includes a movable unit, and an imaging unit mounted on the movable unit and configured to perform imaging through an optical system that includes an optical member rotatable and configured to bend an optical path from an object, the control method comprising:
generating control information for controlling the movable unit, and
controlling a rotation position of the optical member based on an estimated orientation of the movable unit that has been controlled based on the control information.

10. A non-transitory computer-readable storage medium storing a program that causes a computer to execute the control method according to claim 9.
